(19) United States
(12) Patent Application Publication
(10) Pub. No.: US 2019/0375203 A1
(43) Pub. Date: Dec. 12, 2019

(54) Multi-Layered Polylactic Acid - Polyethylene Structure

(71) Applicant: TOTAL RESEARCH & TECHNOLOGY FELUY, Seneffe (BE)

(72) Inventors: Olivier Lhost, Havre (BE); Michel Garny, Limelette (BE); Carmelo Fiorito, Morlanwelz (BE); Marc Dupire, Hyon (BE)

(21) Appl. No.: 16/463,151

(22) PCT Filed: Nov. 21, 2017
(86) PCT No.: PCT/EP2017/079915

§ 371 Date: May 22, 2019

(30) Foreign Application Priority Data
Nov. 22, 2016 (EP) 16200002.0

(51) Int. Cl. B32B 27/32; B32B 27/16; B32B 27/10; B32B 27/08; B32B 27/36

(52) U.S. Cl. CPC B32B 27/327; B32B 27/16; B32B 27/10; B32B 2310/14; B32B 27/36; B32B 2307/3065; B32B 27/08

(57) ABSTRACT

The present invention relates to a multi-layered structure, comprising at least two layers:
a polyethylene layer, comprising polyethylene; and,
a polylactic acid layer, comprising polylactic acid;
   wherein the polyethylene layer is corona-, flame- or plasma-treated.

### FIELD OF INVENTION

The present invention relates to a multi-layered structure comprising a polyethylene layer and a polylactic acid layer.

### BACKGROUND OF THE INVENTION

For packaging, and food or beverage packaging in particular, the barrier properties of the packaging material are crucial. Ideally, the packaging material forms a barrier to both liquids and gasses. With regards to polymers suitable for use in packaging, polyethylene (PE) and polypropylene provide an efficient barrier for water and water vapour but lacks barrier properties for oxygen and aromas, whereas polylactic acid (PLA) may provide an efficient barrier for gasses, especially oxygen gas. However, polylactic acid degrades when in contact with water. Since the barrier properties of various polymers complement each other, a foil comprising multiple layers like a polylactic acid-polyethylene structure might be well suited for packaging, especially food or beverage packaging. The problem with such a structure is that, typically, these two polymers do not well adhere to each other as one polymer provides a hydrophobic surface while the other polymer provides a hydrophilic surface. There is little to no adhesion between the two layers, and they easily delaminate. In the art, this problem has typically been overcome by the addition of additives to one or both of the polymers, or the use of a tie layer between the polyethylene layer and the polylactic acid layer. Such a tie layer, often an extra polymer layer, is often made out a material that is more expensive then the polymer of the layers itself, for example anhydride maleic grafted polyethylene is a common material used as tie layer.

Polylactic acid is known as a “green material” and could be used to at least partly replace polyethylene in applications, yet the need for extra chemicals or extra polymer layers render a multi-layered structure comprising polyethylene and polylactic acid less green. The chemicals are in most cases very reactive and therefore not environmentally friendly or unsuitable in food contact applications.

Therefore, there is a need for multi-layered structures comprising polylactic acid, with excellent barrier properties against water and gasses, such as oxygen gas. There is also a need for multi-layered structures comprising polylactic acid, without the need for extra chemicals or extra polymer layers, while maintaining a significant adhesion force between the layers. There is also a need for multi-layered structures comprising polylactic acid, without the need for extra chemicals or extra polymer layers, so that the structure is suitable for packaging purposes. There is also a need for cost-effective and efficient ways of manufacturing such multi-layered structures comprising polylactic acid, way, preferably with already existing machinery. Further, there is a need for a transparent multilayered structure that possesses barrier properties against water and against gasses.

### SUMMARY OF THE INVENTION

According to a first aspect, the present invention provides a multi-layered structure, comprising at least two layers:
a polyethylene layer, comprising polyethylene; and,
a polylactic acid layer, comprising polylactic acid.

The polyethylene layer is corona-, flame- or plasma-treated, preferably corona-treated. The molecular weight distribution (weight average molecular weight/number average molecular weight) M_{w}/Mₙ of the polyethylene is preferably at least 1.7 to at most 7.0, preferably at least 1.7 to at most 5.0, preferably at least 1.7 to at most 3.2.

In some embodiments, the invention provides in a multi-layered structure, comprising at least two layers:
a polyethylene layer, comprising polyethylene; and,
a polylactic acid layer, comprising polylactic acid;

wherein the polyethylene layer is corona-, flame- or plasma-treated; and,

wherein the polylactic acid layer is in direct contact with the corona-, flame- or plasma-treated side of the polyethylene layer. The molecular weight distribution (weight average molecular weight/number average molecular weight) M_{w}/Mₙ of the polyethylene is preferably at least 1.7 to at most 7.0, preferably at least 1.7 to at most 5.0, preferably at least 1.7 to at most 3.2.

The inventors have surprisingly discovered that the present multi-layered structure does not require any chemical or other polymer layer but still provides a significant adhesion force between the polyethylene layer and the polylactic acid layer. The barrier properties of the polyethylene layer and the polylactic acid layer in the present multi-layered structure complement each other. This may allow fabricating transparent materials with good barrier properties against water and gasses. Classically, an aluminium layer would be present in the material to achieve the wanted barrier properties, taking away the transparency of the material. Furthermore, the polylactic acid layer provides an ecological and renewable alternative to a structure completely manufactured from polyethylene or polypropylene. The significant adhesion force between the two layers avoids the use of non-ecological glues, additives, and/or tie layers. Furthermore, the inventors have found that the present multi-layered structure may be cheaper (as the cost of a tie-layer may be omitted) and comprises adequate mechanical properties for sheets and fibres.

In some embodiments, the polyethylene layer is corona-treated. In some embodiments, the polyethylene layer comprises a polyethylene produced with a single-site catalyst, preferably a metallocene catalyst or post-metallocene catalyst. In some embodiments, the molecular weight distribution M_{w}/Mₙ of the polyethylene is at most 6.5, preferably at most 6.0, preferably at most 5.5. In some embodiments, the molecular weight distribution M_{w}/Mₙ of the polyethylene is at most 5.0. In some embodiments, the molecular weight distribution M_{w}/Mₙ of the polyethylene is at most 4.5, preferably at most 4.0, preferably at most 3.5. In some embodiments, the molecular weight distribution M_{w}/Mₙ of the polyethylene is at most 3.2, preferably at most 3.0, preferably at most 2.8, for example at most 2.7, for example at most 2.6.

In some embodiments, the multi-layered structure is a film. In some embodiments, the multi-layered structure is a fibre, preferably a reinforcing fibre compatible with polyester or polyvinylester resins. In some embodiments, the polylactic acid layer is in direct contact with the polyethylene layer. In some embodiments, the multi-layered structure comprises one or more additional layers selected from the group comprising: fabric, paper, card, cardboard, metal, and polymer.

In some embodiments, the polyethylene is a homopolymer. In some embodiments, the polyethylene is a copolymer with hexene as comonomer, preferably of at least 1 to at most 10 wt % of hexene, more preferably at least 2 to at most 8 wt %, preferably at least 3 to 7wt %, preferably at least 4 to 6wt %, for example 5 wt %, with wt % based on the total weight of the polyethylene, wherein wt % is measured by ¹³C NMR.

In a second aspect, the invention provides an article comprising the multi-layered structure according the first aspect of the invention, and preferred embodiments thereof, preferably wherein the article is a food or beverage packaging article.

In a third aspect, the invention provides a method for manufacturing a multi-layered structure, comprising the steps of:
a. providing a polyethylene layer, comprising polyethylene;
b. corona-, flame- or plasma-treating the polyethylene layer, creating a treated surface; preferably corona-treating the polyethylene layer;
c. providing a polylactic acid layer, comprising polylactic acid; and,
d. depositing the polylactic acid layer on the treated surface;

preferably wherein the polyethylene has a molecular weight distribution (weight average molecular weight/number average molecular weight) M_{w}/Mₙ of at least 1.7 to at most 7.0, preferably of at least 1.7 to at most 5.0.

In some embodiment, the invention provides in a method for manufacturing a multi-layered structure, comprising the steps of:
a. providing a polyethylene layer comprising polyethylene;
b. corona-, flame- or plasma-treating the polyethylene layer, creating a surface-treated layer;
c. providing a polylactic acid layer comprising polylactic acid; and,
d. depositing the polylactic acid layer on the surface-treated side of the surface treated layer;

preferably wherein the polyethylene has a molecular weight distribution (weight average molecular weight/number average molecular weight) M_{w}/Mₙ of at least 1.7 to at most 7.0, preferably of at least 1.7 to at most 5.0.

Preferably, the method according to the third aspect of the invention is for manufacturing a multi-layered structure according to the first aspect of the invention, and preferred embodiments thereof, or for manufacturing an article according to the second aspect of the invention, and preferred embodiments thereof.

In a fourth aspect, the invention provides the use of polylactic acid as a tie layer directly applied on a surface-treated polyethylene layer in a multi-layered structure, preferably wherein the polyethylene layer is corona-, flame- or plasma-treated and/or wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).

In some embodiments, the invention provides in the use of a polylactic acid layer, comprising polylactic acid, as a tie layer directly applied on a corona-, flame- or plasma-treated side of a polyethylene layer, comprising polyethylene, in a multi-layered structure.

The surface treatment makes the polyethylene surface compatible with polar polymers and other polar substances. This way polyethylene can be used in contact with polar polymers, like a laminated structure or embedded, such as reinforcement materials. Preferably, the use according to the fourth aspect of the invention is the use in a multi-layered structure according to the first aspect of the invention, and preferred embodiments thereof, or the use in an article according to the second aspect of the invention, and preferred embodiments thereof.

### DETAILED DESCRIPTION OF THE INVENTION

Before the present method used in the invention is described, it is to be understood that this invention is not limited to particular polymers, structures, articles, methods, and processes described, as such polymers, articles, and processes may, of course, vary. It is also to be understood that the terminology used herein is not intended to be limiting, since the scope of the present invention will be limited only by the appended claims.

When describing the polymers, articles, and processes of the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a composition” means one composition or more than one composition.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any of the embodiments can be used in any combination.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention.

Preferred statements (features) and embodiments of the compositions, articles, processes and uses of this invention are set herein below. Each statement and embodiment of the invention so defined may be combined with any other statement and/or embodiments unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered aspects and embodiments 1 to **57 with any other statement and/or embodiments in the description.
1. Multi-layered structure, comprising at least two layers:
   a polyethylene layer, comprising polyethylene; and,
   a polylactic acid layer, comprising polylactic acid;
wherein the polyethylene layer is corona-, flame- or plasma-treated; preferably wherein the polyethylene layer is corona-treated;
preferably wherein the polylactic acid layer is in direct contact with the corona-, flame- or plasma-treated side of the polyethylene layer;
preferably wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
2. Multi-layered structure according to statement 1, wherein the polyethylene layer is corona-treated.
3. Multi-layered structure according to statement 1 or 2, wherein the molecular weight distribution M_{w}/Mₙ of the polyethylene is at most 5.0, preferably at most 4.5, preferably at most 4.0, preferably at most 3.5.
4. Multi-layered structure according to any one of statements 1 to 3, wherein the molecular weight distribution M_{w}/Mₙ of the polyethylene is at most 3.2, preferably at most 3.0, preferably at most 2.8, for example at most 2.7, for example at most 2.6.
5. Multi-layered structure according to any one of statements 1 to 4, wherein the molecular weight distribution (z-average molecular weight/weight average molecular weight) M_{z}/M_{w} of the polyethylene is at least 1.0 to at most 3.0, preferably at least 1.2 to at most 2.8, preferably at least 1.4 to at most 2.6, preferably at least 1.6 to at most 2.4, for example at least 1.8 to at most 2.2, wherein the molecular weight distribution (z-average molecular weight/weight average molecular weight) M_{z}/M_{w} is measured by size exclusion chromatography (SEC).
6. Multi-layered structure according to any one of statements 1 to 5, wherein the polyethylene layer has a surface tension of at least 34 mN/m, preferably at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to at most 44 mN/m, for example 43 mN/m, wherein the surface tension is measured according to the ISO 8296 (2003) norm.
7. Multi-layered structure according to any one of statements 1 to 6, wherein the polyethylene layer has a surface tension of at least 41 mN/m, preferably at least 42 mN/m.
8. Multi-layered structure according to any one of statements 1 to 7, wherein the multi-layered structure is a film.
9. Multi-layered structure according to any one of statements 1 to 7, wherein the multi-layered structure is a fibre.
10. Multi-layered structure according to statement 9, wherein the multi-layered structure is a reinforcing fibre in a polyester or polyvinylester resin.
11. Multi-layered structure according to any one of statements 1 to 10, wherein the polylactic acid layer is in direct contact with the surface-treated polyethylene layer.
12. Multi-layered structure according to statement 11, wherein between the polyethylene layer and the polylactic acid layer no tie layer, adhesive, or glue are present.
13. Multi-layered structure according to any one of statements 11 or 12, wherein the peeling force between the polyethylene layer and the polylactic acid layer is at least 0.1 N, preferably at least 0.2 N, preferably at least 0.3 N, preferably at least 0.4 N, preferably at least 0.5 N, with the peeling force measured as described in the example section.
14. Multi-layered structure according to any one of statements 1 to 13, wherein the polyethylene layer comprises a polyethylene with a melt flow index (MI2) of at least 0.1 to at most 10.0 g/10 min, preferably at least 0.3 to at most 5.0 g/10 min, wherein the melt flow index is measured according to ISO 1113 2011, condition M, at 190° C. and under a load of 2.16 kg; preferably wherein the multi-layered structure is a film.
15. Multi-layered structure according to any one of statements 1 to 14, wherein the polyethylene layer comprises a polyethylene with a melt flow index (MI2) of at least 0.5 to at most 100.0 g/10 min, preferably at least 1.0 to at most 75.0 g/10 min, preferably at least 2.5 to at most 50.0 g/10 min, preferably at least 3.5 to at most 20.0 g/10 min, preferably at least 5.0 to at most 20.0 g/10 min, wherein the melt flow index is measured according to ISO 1113 2011, condition M, at 190° C. and under a load of 2.16 kg; preferably wherein the multi-layered structure is a fibre.
16. Multi-layered structure according to any one of statements 1 to 15, wherein the polyethylene layer comprises a polyethylene with a density from 0.910 to 0.975 g/cm³, preferably 0.915 to 0.940 g/cm³, preferably 0.917 to 0.930 g/cm³, like 0.918 cm³, 0.921 g/cm³, 0.923 g/cm³ or 0.924 g/cm³, wherein the density is measured according to ISO 1183, 2004; preferably wherein the multi-layered structure is a film.
17. Multi-layered structure according to any one of statements 1 to 16, wherein the polyethylene layer comprises a polyethylene with a density from 0.910 to 0.975 g/cm³, preferably 0.915 to 0.970 g/cm³, preferably 0.953 to 0.965 g/cm³, wherein the density is measured according to ISO 1183, 2004; preferably wherein the multi-layered structure is a fibre.
18. Multi-layered structure according to any one of statements 1 to 17, wherein the polyethylene layer comprises a polyethylene produced with a single-site catalyst, a Ziegler-Natta catalyst, or a chromium catalyst; preferably with a single-site catalyst such as a metallocene or post-metallocene catalyst, preferably with a metallocene catalyst.
19. Multi-layered structure according to any one of statements 1 to 18, wherein the polyethylene layer comprises a polyethylene with a melting temperature from at least 100 to at most 142° C., preferably at least 110 to at most 135° C., wherein the melting temperature is measured according to ISO 11357, 1997.
20. Multi-layered structure according to any one of statements 1 to 19, comprising at least a second polyethylene layer, wherein the second polyethylene layer is corona-, flame- or plasma-treated; preferably wherein the second polyethylene layer is corona-treated.
21. Multi-layered structure according to statement 20, wherein the molecular weight distribution (weight average molecular weight/number average molecular weight) M_{w}/Mₙ of the second polyethylene is at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
22. Multi-layered structure according to statement 20 or 21, wherein the second polyethylene layer has a surface tension of at least 34 mN/m, preferably at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to at most 44 mN/m, for example at least 41 mN/m, for example at least 42 mN/m, for example about 43 mN/m, wherein the surface tension is measured according to the ISO 8296 (2003) norm.
23. Multi-layered structure according to any one of statements 20 to 22, wherein the second polyethylene layer comprises a polyethylene with a melt flow index (MI2) of at least 0.1 to at most 100.0 g/10 min, preferably at least 0.5 to at most 75.0 g/10 min, preferably at least 1.0 to at most 50.0 g/10 min, preferably at least 3.0 to at most 20.0 g/10 min, preferably at least 5.0 to at most 10.0 g/10 min wherein the melt flow index is measured according to ISO 1113 2011, condition M, at 190° C. and under a load of 2.16 kg. preferably wherein the multi-layered structure is a fibre; or wherein the second polyethylene layer comprises a polyethylene with a melt flow index (MI2) of at least 0.1 to at most 10.0 g/10 min, preferably at least 0.3 to at most 5.0 g/10 min, wherein the melt flow index is measured according to ISO 1113 2011, condition M, at 190° C. and under a load of 2.16 kg, preferably wherein the multi-layered structure is a film.
24. Multi-layered structure according to any one of statements 20 to 23, wherein the second polyethylene layer comprises a polyethylene with a density from 0.910 to 0.975 g/cm³, preferably 0.915 to 0.970 g/cm³, preferably 0.953 to 0.965 g/cm³, like 0.918 cm³, 0.921 g/cm³, 0.923 g/cm³ or 0.924 g/cm³, preferably wherein the multi-layered structure is a fibre; or wherein the second polyethylene layer comprises a polyethylene with a density from 0.910 to 0.975 g/cm³, preferably 0.915 to 0.940 g/cm³, preferably 0.917 to 0.930 g/cm³, like 0.918 cm³, 0.921 g/cm³, 0.923 g/cm³ or 0.924 g/cm³, wherein the density is measured according to ISO 1183, 2004, preferably wherein the multi-layered structure is a film.
25. Multi-layered structure according to any one of statements 20 to 24, wherein the second polyethylene layer comprises a polyethylene produced with a single-site catalyst, a Ziegler-Natta catalyst, or a chromium catalyst; preferably with a single-site catalyst, preferably a metallocene catalyst.
26. Multi-layered structure according to any one of statements 20 to 25, wherein the second polyethylene layer comprises a polyethylene with a melting temperature from at least 100 to at most 142° C., preferably at least 110 to at most 135° C., wherein the melting temperature is measured according to ISO 11357, 1997.
27. Multi-layered structure according to any one of statements 20 to 26, wherein the peeling force between the second polyethylene layer and the polylactic acid layer is at least 0.1 N, preferably at least 0.2 N, preferably at least 0.3 N, preferably at least 0.4 N, preferably at least 0.5N, with the peeling force measured as described in the example section.
28. Multi-layered structure according to any one of statements 1 to 27, comprising; besides the polyethylene layer, the polylactic acid layer, and the optional second polyethylene layer; one or more additional layers chosen from the list comprising: fabric, paper, card, cardboard, metal, and polymer.
29. Multi-layered structure according to any one of statements 1 to 28, wherein the thickness of the polyethylene layer is at least 0.001 mm to at most 10.000 mm, preferably at least 0.005 mm to at most 2.000 mm, preferably at least 0.010 mm to at most 1.000 mm, preferably at least 0.020 mm to at most 0.400 mm, preferably at least 0.050 mm to at most 0.250 mm.
30. Multi-layered structure according to any one of statements 1 to 29, wherein the thickness of the optional second polyethylene layer is at least 0.001 mm to at most 10.000 mm, preferably at least 0.005 mm to at most 2.000 mm, preferably at least 0.010 mm to at most 1.000 mm, preferably at least 0.020 mm to at most 0.400 mm, preferably at least 0.050 mm to at most 0.250 mm.
31. Multi-layered structure according to any one of statements 1 to 30, wherein the thickness of the polylactic acid layer is at least 0.001 mm to at most 10.000 mm, preferably at least 0.005 mm to at most 2.000 mm, preferably at least 0.010 mm to at most 1.000 mm, preferably at least 0.020 mm to at most 0.400 mm, preferably at least 0.050 mm to at most 0.250 mm, and wherein the multilayered structure is a film.
32. Multi-layered structure according to any one of statements 1 to 31, wherein the thickness of the polylactic acid layer is at least 0.001 mm to at most 5.000 mm, preferably at least 0.005 mm to at most 1.000 mm, preferably at least 0.010 mm to at most 0.400 mm, preferably at least 0.015 mm to at most 0.250 mm, preferably at least 0.020 mm to at most 0.30 mm, and wherein the multilayered structure is a fibre.
33. Multi-layered structure according to any one of statements 1 to 32, wherein the polyethylene layer has been extruded.
34. Multi-layered structure according to any one of statements 1 to 33, wherein the optional second polyethylene layer has been extruded.
35. Multi-layered structure according to any one of statements 1 to 34, wherein the polylactic acid layer has been extruded.
36. Multi-layered structure according to any one of statements 1 to 35, wherein the polyethylene is a polyethylene random copolymer.
37. Multi-layered structure according to any one of statements 1 to 36, wherein the polyethylene is a homopolymer; preferably wherein the multi-layered structure is a fibre.
38. Multi-layered structure according to any one of statements 1 to 37, wherein the polyethylene is a copolymer, preferably with hexene as comonomer, preferably with at least 0 to at most 10 wt % of hexene, more preferably at least 1 to at most 4 wt %, wherein wt % is measured by ¹³C NMR.
39. Use of polylactic acid as a tie layer directly applied on a polyethylene layer in a multi-layered structure.
40. Use according to statement 39, wherein the polyethylene layer is corona-, flame- or plasma-treated; preferably corona-treated.
41. Use according to any one of statements 39 or 40, wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
42. Use according to any one of statements 39 to 41, wherein the molecular weight distribution M_{w}/Mₙ of the polyethylene is at most 5.0, preferably at most 4.5, preferably at most 4.0, preferably at most 3.5
43. Use according to any one of statements 39 to 42, wherein the molecular weight distribution M_{w}/Mₙ of the polyethylene is at most 3.2, preferably at most 3.0, preferably at most 2.8, for example at most 2.7, for example at most 2.6.
44. Use according to any one of statements 39 to 43, in a multi-layered structure according to any one of statements 1 to 38 or any one of statements 58 to 60.
45. Method for manufacturing a multi-layered structure comprising the comprising the steps of:
   a. providing a polyethylene layer comprising polyethylene;
   b. corona-, flame- or plasma-treating the polyethylene layer, creating a surface-treated layer; preferably corona-treating the polyethylene layer;
   c. providing a polylactic acid layer comprising polylactic acid; and,
   d. depositing the polylactic acid layer on the surface-treated layer; for example by depositing the polylactic acid layer on the surface-treated side of the surface treated layer;
preferably wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
46. Method according to statement 45, wherein the polyethylene layer is corona-treated.
47. Method according to statement 45 or 46, wherein the molecular weight distribution M_{w}/Mₙ of the polyethylene is at most 5.0, preferably at most 4.5, preferably at most 4.0, preferably at most 3.5
48. Method according to any one of statements 45 to 47, wherein the molecular weight distribution M_{w}/Mₙ of the polyethylene is at most 3.2, preferably at most 3.0, preferably at most 2.8, for example at most 2.7, for example at most 2.6.
49. Method according to any one of statements 45 to 48, wherein the molecular weight distribution (z-average molecular weight/weight average molecular weight) M_{z}/M_{w} of the polyethylene is at least 1.0 to at most 3.0, preferably at least 1.2 to at most 2.8, preferably at least 1.4 to at most 2.6, preferably at least 1.6 to at most 2.4, for example at least 1.8 to at most 2.2, wherein the molecular weight distribution (z-average molecular weight/weight average molecular weight) M_{z}/M_{w} is measured by size exclusion chromatography (SEC).
50. Method according to any one of statements 45 to 49, further comprising the steps of:
   e. providing a second polyethylene layer;
   f. corona-, flame- or plasma-treating the second polyethylene layer, creating a second surface-treated layer; preferably corona-treating the second polyethylene layer; and,
   g. depositing the polylactic acid layer on the second surface-treated layer.
51. Method according to any one of statements 45 to 50, wherein the corona-, flame- or plasma-treatment is carried out until a surface tension of at least 34 mN/m is reached, preferably at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to 44 mN/m, for example at least 41 mN/m, for example at least 42 mN/m, for example about 43 mN/m, wherein the surface tension is measured according to ISO 8296 (2003) norm.
52. Method according to any one of statements 45 to 51, wherein the layers which are deposited on top of one another are calendared.

53. Method according to any one of statements 45 to 52, wherein the polyethylene layer, the optional second polyethylene layer, and/or the polylactic acid layer are extruded.
54. Method according to any one of statements 45 to 53, for manufacturing a multi-layered structure according to any one of statements 1 to 38 or any one of statements 58 to 60.
55. Article comprising the multi-layered structure according to any one of statements 1 to 38 or any one of statements 58 to 60, or comprising a multi-layered structure manufactured according to the method according to any one of statements 45 to 54 or any one of statements 65 to 68.
56. Article according to statement 55 wherein the article is a food packaging article.
57. Article according to statement 55 wherein the article is a beverage packaging article.
58. Multi-layered structure, comprising at least two layers:
   a polyethylene layer, comprising polyethylene; and,
   a polylactic acid layer, comprising polylactic acid;
wherein the polyethylene layer is corona-, flame- or plasma-treated; and,
wherein the polylactic acid layer is in direct contact with the corona-, flame- or plasma-treated side of the polyethylene layer.
59. Multi-layered structure of statement 58 and any one of statements 1 to 38.
60. Multi-layered structure according to statement 58, 59 or any one of statements 1 to 38, wherein the molecular weight distribution (weight average molecular weight/number average molecular weight) M_{w}/Mₙ of the polyethylene is at least at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
61. Use of a polylactic acid layer, comprising polylactic acid, as a tie layer directly applied on a corona-, flame- or plasma-treated side of a polyethylene layer, comprising polyethylene, in a multi-layered structure.
62. Use of statement 61 and any one of statements 39 to 44.
63. Use, according to statement 61, 62 or any one of statements 39 to 44wherein the molecular weight distribution (weight average molecular weight/number average molecular weight) M_{w}/Mₙ of the polyethylene is at most 5.0, preferably at most 4.5, preferably at most 4.0, preferably at most 3.5, preferably at most 3.2, preferably at most 3.0, for example at most 2.8, wherein the molecular weight distribution (weight average molecular weight/number average molecular weight) M_{w}/Mₙ is measured by size exclusion chromatography (SEC).
64. Use, according to any one of statement 61 to 63 or any one of statements 39 to 44, of a polylactic acid layer, comprising polylactic acid, as a tie layer directly applied on a polyethylene layer, comprising polyethylene, in a multi-layered structure, wherein the polyethylene layer is corona-, flame- or plasma-treated and/or wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).
65. Method for manufacturing a multi-layered structure, comprising the steps of:
   a. providing a polyethylene layer comprising polyethylene;
   b. corona-, flame- or plasma-treating the polyethylene layer, creating a surface-treated layer;
   c. providing a polylactic acid layer comprising polylactic acid; and,
   d. depositing the polylactic acid layer on the surface-treated side of the surface treated layer.
66. Method of statement 65 and any one of statements 45 to 54.
67. Method according to statement 65, 66 or any one of statements 45 to 54, wherein the molecular weight distribution (weight average molecular weight/number average molecular weight) M_{w}/Mₙ of the polyethylene is at most 5.0, preferably at most 4.5, preferably at most 4.0, preferably at most 3.5, preferably at most 3.2, preferably at most 3.0, for example at most 2.8, wherein the molecular weight distribution (weight average molecular weight/number average molecular weight) M_{w}/Mₙ is measured by size exclusion chromatography (SEC).
68. Method according to any one of statement 65 to 67 or any one of statements 45 to 54, wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).

According to a first aspect, the present invention provides a multi-layered structure, comprising at least two layers:
a polyethylene layer comprising polyethylene; and,
a polylactic acid layer, comprising polylactic acid;

wherein the polyethylene layer is corona-, flame- or plasma-treated; preferably wherein the polyethylene layer is corona-treated;

preferably wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC), for example as detailed below in the test method section for the examples.

In some embodiments the invention provides in, a multi-layered structure, comprising at least two layers:
a polyethylene layer, comprising polyethylene; and,
a polylactic acid layer, comprising polylactic acid;

wherein the polyethylene layer is corona-, flame- or plasma-treated; and,

wherein the polylactic acid layer is in direct contact with the corona-, flame- or plasma-treated side of the polyethylene layer.

In some embodiments, the multi-layered structure, comprises at least two layers:
a polyethylene layer comprising polyethylene; and,
a polylactic acid layer, comprising polylactic acid;

wherein the polyethylene layer is corona-, flame- or plasma-treated; preferably wherein the polyethylene layer is corona-treated;

preferably wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}Mₙ is measured by size exclusion chromatography (SEC), for example as detailed below in the test method section for the examples; and,

wherein the polylactic acid layer is in direct contact with the corona-, flame- or plasma-treated side of the polyethylene layer.

In some preferred embodiments, the molecular weight distribution M_{w}/Mₙ of the polyethylene is at most 5.0, preferably at most 4.5, preferably at most 4.0, preferably at most 3.5. In some preferred embodiments, the molecular weight distribution M_{w}/Mₙ of the polyethylene is at most 3.2, preferably at most 3.0, preferably at most 2.8, for example at most 2.7, for example at most 2.6. In some embodiments, the molecular weight distribution (z-average molecular weight/weight average molecular weight) M_{z}/M_{w} of the polyethylene is at least 1.0 to at most 3.0, preferably at least 1.2 to at most 2.8, preferably at least 1.4 to at most 2.6, preferably at least 1.6 to at most 2.4, for example at least 1.8 to at most 2.2, wherein the molecular weight distribution (z-average molecular weight/weight average molecular weight) M_{z}/M_{w} is measured by size exclusion chromatography (SEC).

As used herein, the molecular weight (Mₙ (number average molecular weight), M_{w} (weight average molecular weight) and molecular weight distributions D (M_{w}/Mₙ), and D′ (M_{z}/M_{w}) were determined by size exclusion chromatography (SEC) and in particular by gel permeation chromatography (GPC).

In some preferred embodiments, the multi-layered structure of the invention comprises at least one polylactic acid layer that is in direct contact with the polyethylene layer. The term “direct” refers to no adhesive or additive being present between the surfaces of the polyethylene layer and the polylactic acid layer. There is at least one polylactic acid-polyethylene interface present in the multi-layered structure. The surface treatment provides a polyethylene layer with a higher surface tension than the surface tension of a pure polyethylene layer.

The polyethylene layer comprises polyethylene. Preferably, the polyethylene layer comprises at least 90.0 wt % polyethylene, with wt % based on the total weight of the polyethylene layer, preferably at least 95.0 wt %, preferably at least 98.0 wt %, preferably at least 99.0 wt %, preferably at least 99.5 wt %, preferably at least 99.8 wt %, preferably at least 99.9 wt %.

Throughout the present application the terms “polyethylene” and “ethylene polymer” may be used synonymously. A “polyethylene layer” is produced from a “polyethylene resin”.

The term “polyethylene resin” as used herein refers to the polyethylene fluff or powder that is extruded, and/or melted, and/or pelleted, and can be produced through compounding and homogenizing of the polyethylene resin as taught herein, for instance, with mixing and/or extruder equipment. It is this polyethylene resin that is used to form the first and/or second and/or any other polyethylene layer.

The term “fluff” or “powder” as used herein refers to the polyethylene material with the hard catalyst particle at the core of each grain and is defined as the polymer material after it exits the polymerization reactor (or final polymerization reactor in the case of multiple reactors connected in series).

In some embodiments, the multi-layered structure comprises at least a second polyethylene layer, wherein the second polyethylene layer is surface-treated, preferably in a way so that the polylactic layer is between, and in direct contact with, the first and second polyethylene layers. This way the polyethylene protects the polylactic acid layer from water or other liquids. The polyethylene layers on both sides of the polylactic acid layer may prolong the lifetime of the multi-layered structure.

In some preferred embodiments, the polyethylene layer is corona-, flame- or plasma-treated on surfaces that are in direct contact, with the polylactic acid layer. In more preferred embodiments, the polyethylene layer is corona-, flame- or plasma-treated on only surfaces that are in contact, preferably direct contact, with the polylactic acid layer.

In some preferred embodiments, the polyethylene layer has a surface tension of at least 34 mN/m, for example at least 41 mN/m, for example at least 42 mN/m. In some preferred embodiments, the polyethylene layer has a surface tension of at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to at most 44 mN/m, for example 43 mN/m, wherein the surface tension is measured according to ISO 8296 (2003) norm, as detailed below in the test methods section of the examples. The peeling force between the two layers is a measurement for the adhesion. Higher surface tension than the given values will cause damage to the treated surface as polymer degradation starts to occur. The peeling force is measured on 1.5 cm width film, sealed as explained in the “test method” part of this document.

In some preferred embodiments, the peeling force between the polyethylene layer and the polylactic acid layer is at least 0.1 N, preferably at least 0.2 N, preferably at least 0.3 N, preferably at least 0.4 N, preferably at least 0.5 N. This results in a multi-layered structure that is suitable for, amongst others, packaging, as the layers do not delaminate easily by handling or shaping the multilayers structure. The same preferably holds for the peeling force between the polylactic acid layer and the optional second polyethylene layer. The peeling force is measured on 1.5 cm width film, sealed as explained in the “test method” part of this document.

In some embodiments, the polyethylene resin has a multimodal molecular weight distribution. In some embodiments, the polyethylene resin has a multimodal density distribution. Preferably, the multimodal polyethylene resin was prepared in at least two separate reactors having different reaction conditions, for example in at least two loop reactors in series.

In some embodiments, the polyethylene resin has a bimodal molecular weight distribution. In some embodiments, the polyethylene resin has a bimodal density distribution. Preferably, the bimodal polyethylene resin was prepared in two separate reactors having different reaction conditions, for example in two loop reactors in series.

In some embodiments, the polyethylene has a bimodal molecular weight distribution. In some embodiments, the polyethylene resin has a monomodal density distribution. Preferably, the monomodal polyethylene resin was prepared in a single reactor.

The polyethylene resin having a multimodal, preferably bimodal, molecular weight distribution can be produced by polymerizing ethylene and one or more optional comonomers, optionally hydrogen, in the presence of a catalyst system. The catalyst may be a metallocene catalyst, a Ziegler-Natta catalyst, or a chromium catalyst; preferably a single site catalyst, such as a post-metallocene catalyst or metallocene catalyst, most preferably a metallocene catalyst.

As used herein, the term “catalyst” refers to a substance that causes a change in the rate of a polymerization reaction. In the present invention, it is especially applicable to catalysts suitable for the polymerization of ethylene to polyethylene.

Suitable ethylene polymerization includes but is not limited to homopolymerisation of ethylene, or copolymerization of ethylene and a higher 1-olefin co-monomer.

As used herein, the term “co-monomer” refers to olefin co-monomers which are suitable for being polymerized with alpha-olefin monomer. Co-monomers may comprise but are not limited to aliphatic C3-C20 alpha-olefins. Examples of suitable aliphatic C3-C20 alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene. In some embodiments of the present invention, the co-monomer is 1-hexene.

In some preferred embodiments, the polyethylene can comprise two fractions. Each fraction can be an ethylene homopolymer or an ethylene copolymer. The polyethylene can be comprise one fraction ethylene homopolymer and another fraction ethylene copolymer. The term “ethylene copolymer” as used herein is intended to encompass polymers which consist essentially of repeat units deriving from ethylene and at least one other C3-C20 alpha olefin co-monomer, preferably the co-monomer is 1-hexene. The term “ethylene homopolymer” as used herein is intended to encompass polymers which consist essentially of repeat units deriving from ethylene. Homopolymers may, for example, comprise at least 99.8% preferably 99.9% by weight of repeats units derived from ethylene.

In some embodiments, the polyethylene resin is prepared in two or more serially connected reactors. In some embodiments, the polyethylene resin comprises two polyethylene fractions A and B, wherein each fraction is prepared in different reactors of two reactors connected in series. The polyethylene resin may be obtained by operating the at least two reactors under different polymerization conditions. In some embodiments, the polyethylene resin was prepared in a single reactor.

The polyethylene resin can be prepared in gas, solution or slurry phase or via a high pressure process, in an autoclave or a tubular process. Slurry polymerization is preferably used to prepare the polyethylene resin composition, preferably in a slurry loop reactor or a continuously stirred reactor.

In some embodiments, the polyethylene resin is prepared in two or more serially connected reactors, comprising at least one first and at least one second reactors, preferably loop reactors, more preferably slurry loop reactors, most preferably liquid full loop reactors in the presence of same or different catalysts. The polymerization process may be carried out in two serially connected slurry loop reactors, advantageously liquid full loop reactors i.e. a double loop reactor. As used herein, the terms “loop reactor” and “slurry loop reactor” may be used interchangeably herein.

The catalyst is preferably added to the loop reactor as catalyst slurry. As used herein, the term “catalyst slurry” refers to a composition comprising catalyst solid particles and a diluent. The solid particles can be suspended in the diluent, either spontaneously or by homogenization techniques, such as mixing. The solid particles can be non-homogeneously distributed in a diluent and form sediment or deposit.

As used herein, the term “diluent” refers to any organic diluent, which does not dissolve the synthesized polyolefin. As used herein, the term “diluent” refers to diluents in a liquid state, liquid at room temperature and preferably liquid under the pressure conditions in the loop reactor. Suitable diluents comprise but are not limited to hydrocarbon diluents such as aliphatic, cycloaliphatic and aromatic hydrocarbon solvents, or halogenated versions of such solvents. Preferred solvents are C12 or lower, straight chain or branched chain, saturated hydrocarbons, C5 to C9 saturated alicyclic or aromatic hydrocarbons or C2 to C6 halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane, preferably isobutane.

In certain embodiments, each loop reactor may comprise interconnected pipes, defining a reactor path. In certain embodiments, each loop reactor may comprise at least two vertical pipes, at least one upper segment of reactor piping, at least one lower segment of reactor piping, joined end to end by junctions to form a complete loop, one or more feed lines, one or more outlets, one or more cooling jackets per pipe, and one pump, thus defining a continuous flow path for a polymer slurry. The vertical sections of the pipe segments are preferably provided with cooling jackets. Polymerization heat can be extracted by means of cooling water circulating in these jackets of the reactor. The loop reactor preferably operates in a liquid full mode.

In certain embodiments, the first loop reactor and second loop reactor, if present, may be connected through means such as a transfer line or one or more settling legs. In some embodiments, the first polyethylene fraction may be transferred from the first loop reactor to the second loop reactor through a transfer line. In some embodiments, the first polyethylene fraction may be discharged in batches, sequentially or continuously from the first loop reactor through one or more settling legs, and transferred to the second loop reactor via a transfer line.

In some embodiments, the polyethylene resin is prepared using a process comprising the steps of:

(a) feeding ethylene monomer, a diluent, at least one catalyst, optionally hydrogen, and optionally one or more olefin co-monomers into at least one first slurry loop reactor; polymerizing the ethylene monomer, and the optionally one or more olefin co-monomers, in the presence of the catalyst, and optional hydrogen, in the first slurry loop reactor to produce a first polyethylene fraction; and

(b) feeding the first polyethylene fraction to a second slurry loop reactor serially connected to the first slurry loop reactor, and in the second slurry loop reactor polymerizing ethylene, and optionally one or more olefin co-monomers, in the presence of the first polyethylene fraction, and optionally hydrogen, thereby producing the catalysed-polyethylene resin.

The polymerization steps can be performed over a wide temperature range. In certain embodiments, the polymerization steps may be performed at a temperature from 20° C. to 125° C., preferably from 60° C. to 110° C., more preferably from 75° C. to 110° C. and most preferably from 78° C. to 108° C. Preferably, the temperature range may be within the range from 75° C. to 110° C. and most preferably from 78° C. to 108° C.

In certain embodiments, the polymerization steps may be performed at a pressure from about 20 bar to about 100 bar, preferably from about 30 bar to about 50 bar, and more preferably from about 37 bar to about 45 bar.

In some embodiments, reactants comprise the monomer ethylene, isobutane as hydrocarbon diluent, a supported catalyst, and optionally at least one co-monomer such as 1-hexene are used.

In some embodiments, the polyethylene resin according to the present invention has a density from 0.910 to 0.975 g/cm³, preferably 0.915 to 0.940 g/cm³, preferably 0.917 to 0.930 g/cm³, like 0.918 cm³, 0.921 g/cm³, 0.923 g/cm³ or 0.924 g/cm³, as measured according to ISO 1183, 2004. Such a density may be particularly preferred for preparing a film, for example a blown film, for example a transparent film.

In some embodiments, the polyethylene resin according to the present invention has a melt index (MI2) of at least 0.1 to at most 10.0 g/10 min, preferably at least 0.3 to at most 5.0 g/10 min, preferably at least 0.5 to at most 2.0 g/10 min, measured according to ISO 1113, 2011, condition M, at 190° C. and under a load of 2.16 kg. Such an MI2 may be particularly preferred for preparing a film, for example a blown film, for example a transparent film.

In some embodiments, the polyethylene resin according to the present invention has a density from 0.910 to 0.975 g/cm³, preferably 0.915 to 0.970 g/cm³, preferably 0.953 to 0.965 g/cm³, wherein the density is measured according to ISO 1183, 2004; preferably wherein the multi-layered structure is a fibre. Such a density may be particularly preferred for preparing a fibre.

In some embodiments, the polyethylene resin according to the present invention has a melt index (MI2) of at least 0.5 to at most 100.0 g/10 min, preferably at least 1.0 to at most 75.0 g/10 min, preferably at least 2.5 to at most 50.0 g/10 min, preferably at least 3.5 to at most 20.0 g/10 min, preferably at least 5.0 to at most 20.0 g/10 min, wherein the melt flow index is measured according to ISO 1113 2011, condition M, at 190° C. and under a load of 2.16 kg. Such an MI2 may be particularly preferred for preparing a fibre.

The polyethylene resin according to the present invention may have a melting temperature of at least 100 to at most 142° C., preferably at least 110 to at most 135° C., as measured according to ISO 11357, 1997.

The polyethylene resin may be compounded with one or more additives, in particular additives such as, by way of example, processing aids, mold-release agents, anti-slip agents, primary and secondary antioxidants, light stabilizers, anti-UV agents, acid scavengers, flame retardants, fillers, nanocomposites, lubricants, antistatic additives, nucleating/clarifying agents, antibacterial agents, plasticizers, colorants/pigments/dyes, sealant resins and mixtures thereof. Illustrative pigments or colorants include titanium dioxide, carbon black, cobalt aluminium oxides such as cobalt blue, and chromium oxides such as chromium oxide green. Pigments such as ultramarine blue, phthalocyanine blue and iron oxide red are also suitable. Specific examples of additives include lubricants and mold-release agents such as calcium stearate, zinc stearate, SHT, antioxidants such as Irgafos®168, Irganox®1010, and Irganox®1076, anti-slip agents such as erucamide, light stabilizers such as Tinuvin®622, Tinuvin®326 and Cyasorb THT®4611, ionomers, and nucleating agents such as Milliken HPN20E™.

In some preferred embodiments, the polyethylene layer and/or optional second layer comprises a polyethylene, more preferably, the first and or second polyethylene layer consist exclusively of a polyethylene. In some embodiments, the polyethylene is a single-site catalysed polyethylene, preferably a metallocene-catalysed polyethylene or a post-metallocene catalysed polyethylene. As used herein, the terms “metallocene-catalysed polyethylene resin”, and “metallocene-catalysed polyethylene” are synonymous and used interchangeably and refers to a polyethylene prepared in the presence of a metallocene catalyst. A similar interpretation is given to the terms “single-site catalysed polyethylene” and “post-metallocene catalysed polyethylene” respectively. The term “metallocene catalyst” is used herein to describe any transition metal complexes comprising metal atoms bonded to one or more ligands. The metallocene catalysts are compounds of Group IV transition metals of the Periodic Table such as titanium, zirconium, hafnium, etc., and have a coordinated structure with a metal compound and ligands composed of one or two groups of cyclopentadienyl, indenyl, fluorenyl or their derivatives. The structure and geometry of the metallocene can be varied to adapt to the specific need of the producer depending on the desired polymer. Metallocenes comprise a single metal site, which allows for more control of branching and molecular weight distribution of the polymer. Monomers are inserted between the metal and the growing chain of polymer.

In one embodiment of the present invention, the metallocene catalyst is a compound of formula (I) or (II)

(Ar)₂MQ₂ (I); or R″(Ar)₂MQ₂ (II),

wherein the metallocenes according to formula (I) are non-bridged metallocenes and the metallocenes according to formula (II) are bridged metallocenes;

wherein the metallocene according to formula (I) or (II) has two Ar bound to M which can be the same or different from each other;

wherein Ar is an aromatic ring, group or moiety and wherein each Ar is independently selected from the group consisting of cyclopentadienyl, indenyl (IND), tetrahydroindenyl (THI), and fluorenyl, wherein each of the groups may be optionally substituted with one or more substituents each independently selected from the group consisting of halogen, hydrosilyl, SiR₃ wherein R is a hydrocarbyl having 1 to 20 carbon atoms, and a hydrocarbyl having 1 to 20 carbon atoms, and wherein the hydrocarbyl optionally contains one or more atoms selected from the group comprising B, Si, S, O, F, Cl, and P;

wherein M is a transition metal selected from the group consisting of titanium, zirconium, hafnium, and vanadium; and preferably is zirconium;

wherein each Q is independently selected from the group consisting of halogen; a hydrocarboxy having 1 to 20 carbon atoms; and a hydrocarbyl having 1 to 20 carbon atoms and wherein the hydrocarbyl optionally contains one or more atoms selected from the group comprising B, Si, S, O, F, Cl, and P; and

wherein R″ is a divalent group or moiety bridging the two Ar groups and selected from the group consisting of C₁-C₂₀ alkylene, germanium, silicon, siloxane, alkylphosphine, and an amine, and

wherein the R″ is optionally substituted with one or more substituents each independently selected from the group consisting of halogen, hydrosilyl, SiR₃ wherein R is a hydrocarbyl having 1 to 20 carbon atoms, and a hydrocarbyl having 1 to 20 carbon atoms and wherein the hydrocarbyl optionally contains one or more atoms selected from the group comprising B, Si, S, O, F, Cl, and P.

Preferably, the metallocene comprises a bridged bis-indenyl and/or a bridged bis-tetrahydrogenated indenyl component. In some embodiments, the metallocene can be selected from one of the following formula (IIIa) or (IIIb):

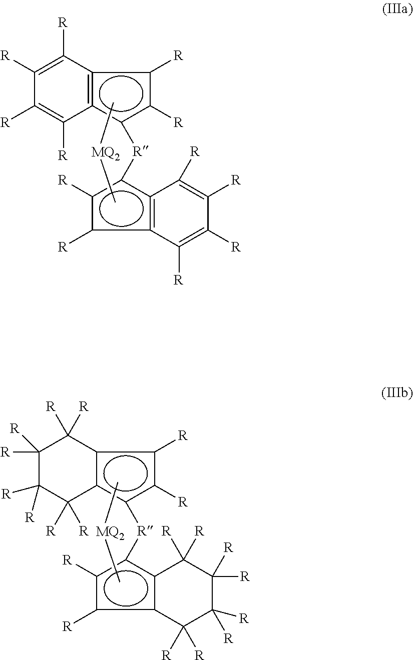

wherein each R in formula (IIIa) or (IIIb) is the same or different and is selected independently from hydrogen or XR′ᵥ in which X is chosen from Group 14 of the Periodic Table (preferably carbon), oxygen or nitrogen and each R′ is the same or different and is chosen from hydrogen or a hydrocarbyl of from 1 to 20 carbon atoms and v+1 is the valence of X, preferably R is a hydrogen, methyl, ethyl, n-propyl, iso-propyl, n-butyl, tert-butyl group; R″ is a structural bridge between the two indenyl or tetrahydrogenated indenyls that comprises a C1-C4 alkylene radical, a dialkyl germanium, silicon or siloxane, or an alkyl phosphine or amine radical; Q is a hydrocarbyl radical having from 1 to 20 carbon atoms or a halogen, preferably Q is F, Cl or Br; and M is a transition metal Group 4 of the Periodic Table or vanadium.

Each indenyl or tetrahydro indenyl component may be substituted with R in the same way or differently from one another at one or more positions of either of the fused rings. Each substituent is independently chosen.

If the cyclopentadienyl ring is substituted, its substituent groups must not be so bulky so as to affect coordination of the olefin monomer to the metal M. Any substituents XR′ᵥ on the cyclopentadienyl ring are preferably methyl. More preferably, at least one and most preferably both cyclopentadienyl rings are unsubstituted.

In a particularly preferred embodiment, the metallocene comprises a bridged unsubstituted bis-indenyl and/or bis-tetrahydrogenated indenyl i.e. all R are hydrogens. More preferably, the metallocene comprises a bridged unsubstituted bis-tetrahydrogenated indenyl.

Illustrative examples of metallocene catalysts comprise but are not limited to bis(cyclopentadienyl) zirconium dichloride (Cp₂ZrCl₂), bis(cyclopentadienyl) titanium dichloride (Cp₂TiCl₂), bis(cyclopentadienyl) hafnium dichloride (Cp₂HfCl₂); bis(tetrahydroindenyl) zirconium dichloride, bis(indenyl) zirconium dichloride, and bis(n-butyl-cyclopentadienyl) zirconium dichloride; ethylenebis(4,5,6,7-tetrahydro-1-indenyl) zirconium dichloride, ethylenebis(1-indenyl) zirconium dichloride, dimethylsilylene bis(2-methyl-4-phenyl-inden-1-yl) zirconium dichloride, diphenylmethylene (cyclopentadienyl)(fluoren-9-yl) zirconium dichloride, and dimethylmethylene [1-(4-tert-butyl-2-methyl-cyclopentadienyl)](fluoren-9-yl) zirconium dichloride. Most preferably the metallocene is ethylene-bis(tetrahydroindenyl)zirconium dichloride or ethylene-bis(tetrahydroindenyl) zirconium difluoride.

As used herein, the term “hydrocarbyl having 1 to 20 carbon atoms” refers to a moiety selected from the group comprising a linear or branched C1-C20 alkyl; C3-C20 cycloalkyl; C6-C20 aryl; C7-C20 alkylaryl and C₇-C₂₀ arylalkyl, or any combinations thereof. Exemplary hydrocarbyl groups are methyl, ethyl, propyl, butyl, amyl, isoamyl, hexyl, isobutyl, heptyl, octyl, nonyl, decyl, cetyl, 2-ethylhexyl, and phenyl.

As used herein, the term “hydrocarboxy having 1 to 20 carbon atoms” refers to a moiety with the formula hydrocarbyl-O—, wherein the hydrocarbyl has 1 to 20 carbon atoms as described herein. Preferred hydrocarboxy groups are selected from the group comprising alkyloxy, alkenyloxy, cycloalkyloxy or aralkoxy groups.

As used herein, the term “alkyl”, by itself or as part of another substituent, refers to straight or branched saturated hydrocarbon group joined by single carbon-carbon bonds having 1 or more carbon atom, for example 1 to 12 carbon atoms, for example 1 to 6 carbon atoms, for example 1 to 4 carbon atoms. When a subscript is used herein following a carbon atom, the subscript refers to the number of carbon atoms that the named group may contain. Thus, for example, C₁₋₁₂alkyl means an alkyl of 1 to 12 carbon atoms. Examples of alkyl groups are methyl, ethyl, propyl, isopropyl, butyl, isobutyl, sec-butyl, tent-butyl, 2-methylbutyl, pentyl and its chain isomers, hexyl and its chain isomers, heptyl and its chain isomers, octyl and its chain isomers, nonyl and its chain isomers, decyl and its chain isomers, undecyl and its chain isomers, dodecyl and its chain isomers. Alkyl groups have the general formula CₙH₂ₙ₊₁.

As used herein, the term “cycloalkyl”, by itself or as part of another substituent, refers to a saturated or partially saturated cyclic alkyl radical. Cycloalkyl groups have the general formula CₙH₂ₙ₋₁. When a subscript is used herein following a carbon atom, the subscript refers to the number of carbon atoms that the named group may contain. Thus, examples of C₃₋₆cycloalkyl include cyclopropyl, cyclobutyl, cyclopentyl, or cyclohexyl.

As used herein, the term “aryl”, by itself or as part of another substituent, refers to a radical derived from an aromatic ring, such as phenyl, naphthyl, indanyl, or 1,2,3,4-tetrahydro-naphthyl. When a subscript is used herein following a carbon atom, the subscript refers to the number of carbon atoms that the named group may contain.

As used herein, the term “alkylaryl”, by itself or as part of another substituent, refers to refers to an aryl group as defined herein, wherein a hydrogen atom is replaced by an alkyl as defined herein. When a subscript is used herein following a carbon atom, the subscript refers to the number of carbon atoms that the named group or subgroup may contain.

As used herein, the term “arylalkyl”, by itself or as part of another substituent, refers to refers to an alkyl group as defined herein, wherein a hydrogen atom is replaced by an aryl as defined herein. When a subscript is used herein following a carbon atom, the subscript refers to the number of carbon atoms that the named group may contain. Examples of C₆₋₁₀arylC₁₋₆alkyl radicals include benzyl, phenethyl, dibenzylmethyl, methylphenylmethyl, 3-(2-naphthyl)-butyl, and the like.

As used herein, the term “alkylene”, by itself or as part of another substituent, refers to alkyl groups that are divalent, i.e., with two single bonds for attachment to two other groups. Alkylene groups may be linear or branched and may be substituted as indicated herein. Non-limiting examples of alkylene groups include methylene (—CH₂—), ethylene (—CH₂—CH₂—), methylmethylene (—CH(CH₃)—), 1-methyl-ethylene (—CH(CH₃)—CH₂—), n-propylene (—CH₂—CH₂—CH₂—), 2-methylpropylene (—CH₂—CH(CH₃)—CH₂—), 3-methylpropylene (—CH₂—CH₂—CH(CH₃)—), n-butylene (—CH₂—CH₂—CH₂—CH₂—), 2-methylbutylene (—CH₂—CH(CH₃)—CH₂—CH₂—), 4-methylbutylene (—CH₂—CH₂—CH₂—CH(CH₃)—), pentylene and its chain isomers, hexylene and its chain isomers, heptylene and its chain isomers, octylene and its chain isomers, nonylene and its chain isomers, decylene and its chain isomers, undecylene and its chain isomers, dodecylene and its chain isomers. When a subscript is used herein following a carbon atom, the subscript refers to the number of carbon atoms that the named group may contain. For example, C₁-C₂₀ alkylene refers to an alkylene having between 1 and 20 carbon atoms.

Exemplary halogen atoms include chlorine, bromine, fluorine and iodine, wherein fluorine and chlorine are preferred.

In some embodiments, said polyethylene is catalyzed by a post-metallocene catalyst. The term “post-metallocene catalyst” refers to a catalyst comprising a central metal in a certain oxidation state, wherein the metal center is not coordinated to two cyclopentadienyl anions. Post-metallocene catalyst are metal complexes, preferably metal complexes comprising metal from the list Ti, Zr, Hf, V, Cr, Fe, Co, Ni or Pd, preferably Ti, Zr, Hf, Fe, Ni or Pd.

In some embodiments, the post-metallocene catalyst is a cyclopentadienyl-amido catalyst, preferably being a Group 4 complex comprising a η⁵-coordinated cyclopentadienyl moiety that is covalently linked to a κ-coordinated amido group. Typically, a short SiMe₂ or a C₂ bridge is present as a linker. Typically the metal center is chosen from Ti, Zr, Hf, preferably Ti. The cyclopentadienyl can be substituted like a single cyclopentadienyl in a metallocene catalyst as disclosed above. In an alternative embodiment, the cyclopentadienyl moiety is replaced by an octamethyloctahydrodibenzofluorenyl moiety.

In some embodiments, said post-metallocene catalyst is a phosphinimide transition-metal catalyst. Preferably Group 4 metals are used in this type of catalyst.

In some embodiments, said post-metallocene catalyst is a Group 4 transition-metal ketimide complexes with the general structure [Cp′M*(N═CR¹R²)X₂] wherein preferably Cp′=C₅H₅, C₅Me₅, indenyl or fluorenyl, preferably M*=Ti, Zr or Hf and preferably X═Cl, Me or Bn; for example, bis(tert-butyl)ketimide (N═CtBu2)-ligated titanium complexes.

In some embodiments, said post-metallocene catalyst is a an iminoimidazolidine catalyst or a amidinate complex of the general structure [(C₅R′₅)Ti—{N═C(Ar)NR″₂}X′₂] wherein X′═Me or Cl.

In some embodiments, said post-metallocene catalyst is a diamido catalyst, preferably a Group 4 complex bearing diamide ligands, preferably [((MesNCH₂CH₂)₂NH)ZrMe₂] or [(ArN(CH₂)₃NAr)TiR*₂] wherein Ar is preferably 2,6-iPr₂C₆H₃ or 2,6-Me₂C₆H₃ and R* is preferably Cl, Me or Bn.

In some embodiments, said post-metallocene catalyst is an imino-amido catalyst, preferably an imino-amido Group 4 complex, more preferably the metal is Hf or Zr.

In another alternative embodiment, said post-metallocene catalyst is a pyridyl-amido catalyst.

In some embodiments, said post-metallocene catalyst is a phenoxyimine catalyst, preferably a phenoxyimine Group 4 transition-metal complex or a Group 4 salicylaldiminato complex.

In some embodiments, said post-metallocene catalyst is a cationic late-transition-metal catalyst, preferably a cationic [Ni^{∥}(diimine)] or a cationic [Pd^{∥}(diimine)] complex. Many post-metallocene catalysts for polyethylene polymerization are known in the art, a large number of these catalysts are disclosed in “Post-metallocenes in the industrial production of Poly-olefins”, by Moritz et al. Angew. Chem. Int. Ed. 2014, 53, 9722-9744, these catalysts are incorporated herein by reference.

The single site catalysts used herein are preferably provided on a solid support. The support can be an inert organic or inorganic solid, which is chemically unreactive with any of the components of the conventional single site catalyst. Suitable support materials for the supported catalyst include solid inorganic oxides, such as silica, alumina, magnesium oxide, titanium oxide, thorium oxide, as well as mixed oxides of silica and one or more Group 2 or 13 metal oxides, such as silica-magnesia and silica-alumina mixed oxides. Silica, alumina, and mixed oxides of silica and one or more Group 2 or 13 metal oxides are preferred support materials. Preferred examples of such mixed oxides are the silica-aluminas. Most preferred is a silica compound. In a preferred embodiment, the single site catalyst is provided on a solid support, preferably a silica support. The silica may be in granular, agglomerated, fumed or other form.

In some embodiments, the support of the single site catalyst is a porous support, and preferably a porous silica support having a surface area comprised between 200 and 900 m²/g. In another embodiment, the support of the polymerization catalyst is a porous support, and preferably a porous silica support having an average pore volume comprised between 0.5 and 4 ml/g. In yet another embodiment, the support of the polymerization catalyst is a porous support, and preferably a porous silica support having an average pore diameter comprised between 50 and 300 Å, and preferably between 75 and 220 Å.

Preferably, the supported single site catalyst is activated. The cocatalyst, which activates the single site catalyst component, can be any cocatalyst known for this purpose such as an aluminium-containing cocatalyst, a boron-containing cocatalyst or a fluorinated catalyst. The aluminium-containing cocatalyst may comprise an alumoxane, an alkyl aluminium, a Lewis acid and/or a fluorinated catalytic support.

In some embodiments, alumoxane is used as an activating agent for the single site catalyst. The alumoxane can be used in conjunction with a catalyst in order to improve the activity of the catalyst during the polymerization reaction.

As used herein, the term “alumoxane” and “aluminoxane” are used interchangeably, and refer to a substance, which is capable of activating the single site catalyst. In some embodiments, alumoxanes comprise oligomeric linear and/or cyclic alkyl alumoxanes. In a further embodiment, the alumoxane has formula (IV) or (V)
R^{a}—(Al(R^{a})—O)ₓ—AlR^{a}₂ (IV) for oligomeric, linear alumoxanes; or
(—Al(R^{a})—O—)_{y} (V) for oligomeric, cyclic alumoxanes
   wherein x is 1-40, and preferably 10-20;
   wherein y is 3-40, and preferably 3-20; and
   wherein each R^{a} is independently selected from a C₁-C₈alkyl, and preferably is methyl.

In a preferred embodiment, the alumoxane is methylalumoxane (MAO).

In a preferred embodiment, the single site catalyst is a supported single site-alumoxane catalyst comprising a single site catalyst and an alumoxane which are bound on a porous silica support. Preferably, the single site catalyst is a bridged bis-indenyl catalyst and/or a bridged bis-tetrahydrogenated indenyl catalyst.

One or more aluminiumalkyl represented by the formula AlR^{b}ₓ can be used as additional co-catalyst, wherein each R^{b} is the same or different and is selected from halogens or from alkoxy or alkyl groups having from 1 to 12 carbon atoms and x is from 1 to 3. Non-limiting examples are Tri-Ethyl Aluminium (TEAL), Tri-Iso-Butyl Aluminium (TIBAL), Tri-Methyl Aluminium (TMA), and Methyl-Methyl-Ethyl Aluminium (MMEAL). Especially suitable are trialkylaluminiums, the most preferred being triisobutylaluminium (TIBAL) and triethylaluminium (TEAL).

The polylactic acid layer comprises polylactic acid. Preferably, the polylactic acid layer comprises at least 90.0 wt % polylactic acid, with wt % based on the total weight of the polylactic acid layer, preferably at least 95.0 wt %, preferably at least 98.0 wt %, preferably at least 99.0 wt %, preferably at least 99.1 wt %, preferably at least 99.2 wt %, preferably at least 99.3 wt %, preferably at least 99.4 wt %, preferably at least 99.5 wt %, preferably at least 99.8 wt %, preferably at least 99.9 wt %. Preferably, the polylactic acid layer comprises at most 0.9 wt % additives, preferably at most 0.8 wt % additives preferably at most 0.7 wt % additives, preferably at most 0.6 wt % additives preferably at most 0.5 wt % additives, preferably at most 0.2 wt % additives and most preferably at most 0,1 wt % additives, with wt % based on the total weight of the polylactic acid layer.

As used herein, the terms “polylactic acid” or “poly-lactide” or “PLA” are used interchangeably and refer to poly(lactic acid) polymers comprising repeat units derived from lactic acid.

The PLA suitable for the invention may be the PLLA (poly-L-lactide), the PDLA (poly-D-lactide) or a mixture thereof. Preferably, PLLA is used.

Preferably, the PLA (PLLA or PDLA) has a number average molecular weight (Mₙ) ranging between 30 kDa and 350 kDa, more preferably between 50 kDa and 175 kDa, even more preferably between 70 kDa and 150 kDa. The number average molecular weight is measured by chromatography by gel permeation compared to a standard polystyrene in chloroform at 25° C. The ratio of the weight average molecular weight (M_{w}) to the number average molecular weight (Mₙ) is generally between 1.0 and 5.0.

In some embodiments, the poly-lactide suitable for the invention has a weight average molecular weight (M_{w}) of at least 40 kDa, preferably at least 100 kDa, for example at least 150 kDa, for example at least 200 kDa, for example at least 250 kDa, for example at least 260 kDa. Measurement of the molecular masses may be performed at 25° C. using a liquid chromatograph PolymerChar system. In an embodiment, the ratio of the weight average molecular weight (M_{w}) to the number average molecular weight (Mₙ) is generally from 1.0 to 5.0, for example from 1.0 to 3.0, preferably from 1.0 to 2.6.

In some embodiments, the poly-lactide (PLLA, PDLA, or PDLLA) may have a density of at least 1.20 g/cm³ to at most 1.50 g/cm³, for example at least 1.21 g/cm³to at most 1.45 g/cm³, preferably at least 1.22 g/cm³ to at most 1.40 g/cm³, preferably at least 1.23 g/cm³ to at most 1.35 g/cm³, preferably at least 1.24 g/cm³ to at most 1.30 g/cm³, as determined in accordance with ASTM D1505 at 23° C.

The poly-lactide suitable for the invention preferably comprises amorphous poly-lactide. As used herein, the term “amorphous” refers to a solid that is non-crystalline and lacks the long-range order characteristics of a crystal.

The process for preparing PLA is well-known by the person skilled in the art. For example it can be obtained by the process describes in documents WO1998/002480, WO 2010/081887, FR2843390, U.S. Pat. Nos. 5,053,522, 5,053,485 or 5,117,008.

Poly-lactide suitable for use in the invention can be prepared using a process comprising the step of contacting at least one L-lactide, D-lactide, or mixtures thereof with a suitable catalyst, and optionally in the presence of a co-initiator. The process may be performed with or without solvent. In some embodiments, the PLA is obtained by polymerizing lactide, in the presence of a suitable catalyst and preferably in the presence of a compound of formula (VI), acting as a co-initiator and transfer agent of the polymerization,

R³—OH (VI)

wherein R³ is selected from the group consisting of C₁₋₂₀alkyl, C₆₋₃₀aryl, and C₆₋₃₀arylC₁₋₂₀alkyl, each group being optionally substituted by one or more substituents selected from the group consisting of halogen, hydroxyl, and C₁₋₆alkyl. Preferably, R³ is a group selected from C₃₋₁₂alkyl, C₆₋₁₀aryl, and C₆₋₁₀arylC₃₋₁₂alkyl, each group being optionally substituted by one or more substituents each independently selected from the group consisting of halogen, hydroxyl, and C₁₋₆alkyl; preferably, R³ is a group selected from C₃₋₁₂alkyl, C₆₋₁₀aryl, and C₆₋₁₀arylC₃₋₁₂alkyl, each group being optionally substituted by one or more substituents each independently selected from the group consisting of halogen, hydroxyl and C₁₋₄alkyl. The alcohol can be a polyol such as diol, triol or higher functionality polyhydric alcohol. The alcohol may be derived from biomass such as for instance glycerol or propanediol or any other sugar-based alcohol such as for example erythritol. The alcohol can be used alone or in combination with another alcohol.

In some embodiments, non-limiting examples of initiators include 1-octanol, isopropanol, propanediol, trimethylolpropane, 2-butanol, 3-buten-2-ol, 1,3-butanediol, 1,4-butanediol, 1,6-hexanediol, 1,7-heptanediol, benzyl alcohol, 4-bromophenol,1,4-benzenedimethanol, and (4-trifluoromethyl)benzyl alcohol; preferably, the compound of formula (VI) is selected from 1-octanol, isopropanol, and 1,4-butanediol.

The catalyst employed for this process may have general formula M(Y¹,Y², . . . Y^{p})_{q}, in which M is a metal selected from the group comprising the elements of columns 3 to 12 of the periodic table of the elements, as well as the elements Al, Ga, In, Tl, Ge, Sn, Pb, Sb, Ca, Mg and Bi; whereas Y¹, Y², . . . Y^{p} are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carbon/late and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl)phenoxy)(ethoxy)zinc, or Zn(lactate)₂.

The term “corona,” as used herein, refers to electrical discharges that occur at substantially atmospheric pressure, and is to be distinguished from electrical discharges that occur under a vacuum, characterized by an intense, diffuse glow in the space between the corona electrode and the discharge electrode, sometimes called “glow” discharge. The corona treatment may be performed on an industrial scale or on a small scale laboratory device, preferably on an industrial scale.

Preferably, the frequency of the current supplied to the corona electrode is in the range of 1 to 100 kHz, preferably 5 to 75 kHz, preferably 10 to 50 kHz, preferably 15 to 25 kHz, like 16 kHz. Suitable current is usually in excess of about 0.5 amps, preferably about 1.0 to 1.5 amps. Preferably the voltage between the corona electrode and the discharge electrode is from 20 kV to 140 kV, preferably from 40 kV to 120 kV, preferably 50 kV to 110 kV, preferably 60 kV to 100 kV, preferably 70 kV to 90 kV, like 80 kV. The distance between the corona electrode and the discharge electrode is generally less than 2.50 cm, preferably less than 1.00 cm, preferably 1 to 5 mm, like 1.75 mm although the space largely depends upon the voltage applied across the two electrodes.

Numerous shapes and types of electrodes have been employed for corona treatment. Any electrode shape or size may be employed herein which will produce a corona between the electrodes over the transverse portion of the film desired to treated. Different corona electrodes are preferably placed 1 to 20 cm apart preferably 2 to 18 cm apart, preferably 4 to 16 cm apart, preferably 6 to 14 cm apart, preferably 8 to 12 cm and most preferably 10 cm apart. The discharge electrode is preferably a grounded electrode roll. The grounded roll is connected to the ground on the generator terminal.

The corona treatment utilized in the present invention may be characterized in terms of a “normalized energy” which is calculated from the net power and the relative velocity of the polymer film being treated to the corona electrode in the corona treatment system, according to the following formula:

normalized energy E=P/w v

where P is the net power (in Watts), w is the corona treatment electrode width (in cm), and v is the film velocity (in cm/s) Typical units for normalized energy are Joules/square centimetre In preferred embodiments of the present invention, the corona discharge is characterized by having a normalized energy of from 0.1 to 100 J/cm², preferably from 1 to 75 J/cm², preferably from 5 to 50 J/cm², preferably from 10 to 20, J/cm².

Alternatively the corona treatment may be characterised by the surface tension of the treated polymer.

The corona treatment can be carried out in a controlled atmosphere, preferably the atmosphere contains nitrogen and from about 0.01 to about 10 volume percent hydrogen gas ammonia or a mixture of hydrogen gas and ammonia. Preference is given to Corona treatment carried out in air. The corona treatment may be performed in any corona treatment system capable of controlling atmospheric gas conditions. Corona treaters adaptable for use in the present invention are commercially available, for example from Sherman Treaters, Ltd. (Theme, UK), Enercon Indus. Corp. (Menomonee Falls, Wis.), and Pillar Technologies (Hartland, Wis.).

In some preferred embodiments, the multi-layered structure comprises, besides the polyethylene layer, the polylactic acid layer and the optional second polyethylene, one or more additional layers selected from the group comprising: fabric, paper, card, cardboard, metal or polymer. Such an additional layer may further improve the barrier properties of the multi-layered structure, or may serve to alter the mechanical properties of the multi-layered structure.

In a preferred embodiment, the multi-layered structure is a film, e.g. a foil. The layers of the multi-layered structure can be produced by any conventional technique known in the art, but preferably by extrusion, more preferably blow film extrusion or sheet extrusion.

In another preferred embodiment, the multi-layered structure is a fibre. Preferably, the fibre comprises a core of polyethylene and at least one polylactic acid shell. The fibre core can be produced by any conventional technique known in the art, but preferably by a spinning technique, more preferably wet, dry, dry jet-wet, melt, gel, electrospinning or forcespinning. Polyethylene can be spun in a fibre having a high tenacity. However, the surface of the polyethylene fibres is apolar, whereas polyester and polyvinyl esters resins are polar, causing incompatibility between the fibres and the resin. The invention solves this incompatibility by providing the polylactic acid shell, as the surface of the polylactic shell is polar. In a fibre, the shape is different from a film. In multicomponent fibres, the “layers”, as mentioned herein, may be considered “cylindrical” layers. In some embodiments, the multi-layered structure is a fibre, comprising a core and at least one shell. Preferably, the fibre comprises a core of polyethylene and at least one polylactic acid shell. Preferably the core is surface treated by corona-, flame- or plasma-treatment. Methods for surface treating fibres are known in the art. The core of the fibre may first be treated, and subsequently be coated by the shell.

In some embodiments, the multi-layered structure comprises at least two layers:
a polyethylene layer, comprising polyethylene; and,
a polylactic acid layer, comprising polylactic acid;

wherein the polyethylene layer is corona-, flame- or plasma-treated; and,

wherein the polylactic acid layer is in direct contact with the corona-, flame- or plasma-treated side of the polyethylene layer;

wherein the molecular weight distribution (weight average molecular weight/number average molecular weight) M_{w}/Mₙ of the polyethylene at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC); and,

wherein the polyethylene layer has a surface tension of at least 41 mN/m, preferably at least 42 mN/m.

In a second aspect, the invention provides article comprising the multi-layered structure according the first aspect of the invention, and preferred embodiments thereof, preferably a food or beverage packaging.

In a third aspect, the invention provides a method for manufacturing a multi-layered structure comprising the steps of:
a. providing a polyethylene layer comprising polyethylene;
b. corona-, flame- or plasma-treating the polyethylene layer, creating a surface-treated layer; preferably corona-treating the polyethylene layer;
c. providing a polylactic acid layer comprising polylactic acid; and,
d. depositing the polylactic acid layer on the surface-treated layer;

preferably wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC). Preferably the method according to the third aspect is for manufacturing a multi-layered structure according to the first aspect, and preferred embodiments thereof.

In some embodiments, the invention provides in a method for manufacturing a multi-layered structure, comprising the steps of:
a. providing a polyethylene layer comprising polyethylene;
b. corona-, flame- or plasma-treating the polyethylene layer, creating a surface-treated layer;
c. providing a polylactic acid layer comprising polylactic acid; and,
d. depositing the polylactic acid layer on the surface-treated side of the surface treated layer.

In some embodiments, step d. is performed by depositing the polylactic acid layer on the surface- treated side of the surface-treated layer.

In some preferred embodiments, the method further comprises the steps of:
e. providing a second polyethylene layer;
f. corona-, flame- or plasma-treating the second polyethylene layer, creating a second surface-treated layer; preferably corona-treating the second polyethylene layer; and,
g. depositing the polylactic acid layer on the second surface-treated layer.

In some preferred embodiments, the surface treatment is carried out until a surface tension is reached of at least 34 mN/m, preferably at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to at most 44 mN/m, for example 43 mN/m.

In some preferred embodiments, the on top of each other deposited layers are calendared.

In some preferred embodiments, the polyethylene layer, the optional second polyethylene layer, and/or the polylactic acid layer are extruded.

In some preferred embodiments, the polylactic acid layer is extruded on top of the surface treated polyethylene layer. In some preferred embodiments, the polylactic acid layer is extruded between the surface treated first polyethylene layer and the corona treated second polyethylene layer.

In a fourth aspect, the invention provides the use of polylactic acid as a tie layer directly applied on a polyethylene layer in a multi-layered structure. The term “directly” herein refers to no other substances being present between the surfaces of the polyethylene layer and the polylactic acid layer. The term “tie layer” refers to a layer that is applied between two not compatible surfaces to physically bind these surfaces together. PLA is not traditionally considered a tie layer in a polyethylene structure. However, in the present invention it may be used as such.

In some embodiments, the invention provides in the use of a polylactic acid layer, comprising polylactic acid, as a tie layer directly applied on a corona-, flame- or plasma-treated side of a polyethylene layer, comprising polyethylene, in a multi-layered structure.

In some preferred embodiments, the polyethylene layer is surface-treated, and preferably the surface treatment is carried out until a surface tension of at least 34 mN/m is reached, preferably at least 36 to at most 50 mN/m, preferably at least 38 to at most 48 mN/m, preferably at least 39 to at most 47 mN/m, preferably at least 40 to at most 46 mN/m, preferably at least 41 to at most 45 mN/m, preferably at least 42 to 44 mN/m, for example 43 mN/m.

In some preferred embodiments, the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).

In some embodiments, the invention provides in the use of a polylactic acid layer, comprising polylactic acid, as a tie layer directly applied on a polyethylene layer, comprising polyethylene, in a multi-layered structure, wherein the polyethylene layer is corona-, flame- or plasma-treated and/or wherein the molecular weight distribution (weight average molecular weight/number average molecular weight) M_{w}/Mₙ of the polyethylene is at least 1.7 to at most 7.0, preferably at least 1.7 to at most 6.5, preferably at least 1.7 to at most 6.0, preferably at least 1.7 to at most 5.5, preferably at least 1.7 to at most 5.0, preferably at least 1.8 to at most 4.5, preferably at least 1.9 to at most 4.0, preferably at least 2.0 to at most 3.5, preferably at least 2.1 to at most 3.2, preferably at least 2.2 to at most 3.0, for example at least 2.3 to at most 2.8, wherein the molecular weight distribution (weight average molecular weight/number average molecular weight) M_{w}/Mₙ is measured by size exclusion chromatography (SEC).

### EXAMPLES

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

Test Methods:

The molecular weight (Mₙ (number average molecular weight), M_{w} (weight average molecular weight, and M_{z} (z average molecular weight)) and molecular weight distributions d (M_{w}/Mₙ, polydispersity index), and d′ (M_{z}/M_{w}) were determined by size exclusion chromatography (SEC) and in particular by gel permeation chromatography (GPC). Briefly, a GPC-IR5 from Polymer Char was used: 10 mg polyethylene sample was dissolved at 160° C. in 10 ml of trichlorobenzene for 1 hour. Injection volume: about 400 μl, automatic sample preparation and injection temperature: 160° C. Column temperature: 145° C. Detector temperature: 160° C. Two Shodex AT-806MS (Showa Denko) and one Styragel HT6E (Waters) columns were used with a flow rate of 1 ml/min. Detector: Infrared detector (2800-3000cm⁻¹). Calibration: narrow standards of polystyrene (PS) (commercially available). Calculation of molecular weight Mi of each fraction i of eluted polyethylene was based on the Mark-Houwink relation (log₁₀(M_{PE})=0.965909−log₁₀(M_{PS})−0.28264) (cut off on the low molecular weight end at M_{PE}=1000).

The molecular weight averages used in establishing molecular weight/property relationships are the number average (Mₙ), weight average (M_{w}), and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i } / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {W}_{i}} = \frac{{\sum }_{i} {h}_{i} {M}_{i}}{{\sum }_{i} {h}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mᵢ. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment. The density of the polyethylene was measured according to the method of standard ISO 1183 at a temperature of 23° C.

The melt flow index (MFI or MI₂) of the polyethylene was measured according to the method of standard ISO 1133, condition M, at 190° C. and under a load of 2.16 kg.

The total co-monomer content, especially 1-hexene (wt % C6) relative to the total weight of the ethylene polymer and the molar fraction of hexene co-monomer in sequences of length one relative to the co-monomer content were determined by ¹³C NMR analysis according to the state of the art of ¹³C NMR analysis of ethylene based polyolefins. The ¹³C NMR analysis was performed under conditions such that the signal intensity in the spectrum is directly proportional to the total number of contributing carbon atoms in the sample. Such conditions are well known to the skilled person and include for example sufficient relaxation time etc. In practice, the intensity of a signal is obtained from its integral, i.e. the corresponding area. The data were acquired using proton decoupling, several hundred even thousands scans per spectrum, at a temperature of 130° C. The sample was prepared by dissolving a sufficient amount of polymer in 1,2,4-trichlorobenzene (TCB 99% spectroscopic grade) at 130° C. and occasional agitation to homogenize the sample, followed by the addition of hexadeuterobenzene (C6D6, spectroscopic grade) and a minor amount of hexamethyldisiloxane (HMDS, 99.5+%), with HMDS serving as internal standard. To give an example, about 200 to 600 mg of polymer were dissolved in 2.0 ml of TCB, followed by addition of 0.5 ml of C6D6 and 2 to 3 drops of HMDS. The chemical shifts are referenced to the signal of the internal standard HMDS, which is assigned a value of 2.03 ppm. The ¹³C NMR observed signals were assigned according to the comonomer involved and corresponding literature. The following non-exhaustive literature references can be used: G. J. Ray et al. in Macromolecules, vol 10, n°4, 1977, p. 773-778 and Y. D Zhang et al in Polymer Journal, vol 35, n°7, 2003, p. 551-559.

The total co-monomer content relative to the total weight of ethylene polymer was determined from the appropriate peaks area combination, a well-known method to the skilled person. The surface tension was measured according to ISO 8296 (2003) norm, “Standard test method for wetting tension of polyethylene and polypropylene films”. Care was taken that the portion of the film to be tested was not touched or rubbed and was completely free of any contamination. A series of test solutions (mixtures of formamide and ethylene glycolmonoethyl ether) with gradually increasing surface tension were applied to the surface until a mixture was found that just wets the film surface. The solution was considered as wetting the test specimen when it remains intact as a continuous film line for 2 seconds. The surface tension of the last mixture which properly wets the film was the determined wetting tension of the film sample.

The peeling force was measured according to the following method:
a) The two films were sealed together on a Brugger HSG-C 951 heat-sealing machine.
Sealing was performed under the following conditions:
   a. Temperature: various temperatures, from 110° C. to 190° C. with an increment of 5 or 10° C., were considered;
   b. Pressure: 10 N, imposed on the jaws of 150 mm by 10 mm;
   c. Sealing time: 3.5 s
b) The sealed films were stored for 24 hours at a temperature of 23° C. and a humidity of ca 50%;
c) Film strips, 1.5 cm width, were cut from the sealed films. Each strip thus contains a sealed surface of 1.5*1 cm²;
d) Adhesion force was determined by pulling apart the seal in a Zwick Z 2.5/TH1S at a speed of 200 mm/min. Following ASTM D88 norm and recording the maximum force necessary to pull the seal apart. The results are provided in N.
To translate these adhesion force measurements into delamination toughness (usually references as G in the literature—see e.g. P. Dias et al. Polymer 49, 2937 (2008)), the adhesion force (in N) has to be multiplied by 2 and divided by the width (0.015 m). The obtained delamination toughness is then expressed in J m⁻²;

In fact, only adhesion force associated to a peeling mechanism have been considered. When comparing these values to the peeling force measured on a multilayer structure directly produced on a pilot calendaring equipment, the adhesion force measured in the multilayer structure produced in the pilot-line also corresponds to the maximum force (amongst forces measured at different temperatures) measured on films sealed in the Brugger HSG-C 951 heat-sealing machine.

Materials:

PE1

Polyethylene PE1 is commercially available from Total Refining & Chemicals as Lumicene® M 2310 EP. Table 1 shows the properties of polyethylene PE1.

TABLE 1

| | Unit | PE1 |
|---|---|---|
| Density (23° C.) | g/cm³ | 0.923 |
| MI2 (190° C., 2.16 kg) | g/10 min | 0.9 |
| Fusion temperature | ° C. | 116 |
| Catalyst | | metallocene |
| Mₙ | Da | 35600 |
| M_{w} | Da | 86800 |
| M_{z} | Da | 163000 |
| M_{w}/Mₙ | | 2.44 |
| M_{z}/M_{w} | | 1.88 |

PE2

PE2, having the properties listed in Table 2,is commercially available from Total Refining & Chemicals as Lumicene® Supertough 22ST05. Table 2 shows the properties of polyethylene PE2.

TABLE 2

| | Unit | PE2 |
|---|---|---|
| Density (23° C.) | g/cm³ | 0.922 |
| MI2 (190° C., 2.16 kg) | g/10 min | 0.5 |
| Fusion temperature | ° C. | 113 |
| Catalyst | | metallocene |
| Mₙ | Da | 26400 |
| M_{w} | Da | 95500 |
| M_{z} | Da | 222000 |
| M_{w}/Mₙ | | 3.62 |
| M_{z}/M_{w} | | 2.32 |

PE3

Polyethylene PE3 is commercially available from Total Refining & Chemicals as LDPE FE 8000. Table 3 shows the properties of polyethylene PE3.

TABLE 3

| | Unit | PE3 |
|---|---|---|
| Density (23° C.) | g/cm³ | 0.924 |
| MI2 (190° C., 2.16 kg) | g/10 min | 0.8 |
| Fusion temperature | ° C. | 111 |
| Catalyst | | radicalar |
| Mₙ | Da | 16700 |
| M_{w} | Da | 94500 |
| M_{z} | Da | 325000 |
| M_{w}/Mₙ | | 5.66 |
| M_{z}/M_{w} | | 3.44 |

PLA1

PLA1 stands for an amorphous PLLA with a D-isomer content of 11% by weight, as measured by NMR. Polylactic acid PLA1 is commercially available from NatureWorks LLC as Ingeo™ Biopolymer 4060D.

Table 4 shows the properties of polyethylene PLA1.

TABLE 4

| | Unit | PLA1 |
|---|---|---|
| Mₙ | Da | 111000 |
| M_{w} | Da | 234000 |
| M_{z} | Da | 369000 |
| M_{w}/Mₙ | | 2.11 |
| M_{z}/M_{w} | | 1.58 |

Polypropylene PP1 is commercially available from Total Refining & Chemicals as PPH3060. Table 5 shows the properties of polypropylene PP1.

TABLE 5

| | Unit | PE3 |
|---|---|---|
| MFI (230° C., 2.16 kg) | g/10 min | 1.8 |
| Fusion temperature | ° C. | 162 |
| Mₙ | Da | 65400 |
| M_{w} | Da | 437000 |
| M_{z} | Da | 1880000 |
| M_{w}/Mₙ | | 6.7 |
| M_{z}/M_{w} | | 4.3 |

Extrusion of Polymer Film

For the preparation of the polymer (polylactic acid, polyethylene, or polypropylene) layer, a Samafor single screw extruder provided at the extruder outlet with a calendering system, was used. The resulting sheets had a thickness of about 65 μm (+/−3%).

The temperature profile along the extruder barrel was 220° C., and the temperature of the die (the aperture at the die is 0.7 mm thick, 500 mm long) was 240° C. The screw speed was 26 rpm, the residence time of 3 min.

Corona Treatment of Films

Films of PE1-3 were extruded according to the above mentioned extrusion method. These films were subsequently corona treated thanks to a regular scanning of the film using a Mini-corona equipment commercialized by Boussey (http://www.boussey-control.com/tension-superficielle/traitement-corona_laboratoire.htm). When treating the (polyethylene or polypropylene) film, great care is taken to maintain a constant distance between the film and the mini-corona equipment and to move the mini-corona-equipment at a constant speed over the whole film. When finishing the treatment of the whole film, a quantification of the corona treatment is performed according to the method disclosed above.

Corona Treatment of Fibres

Corona treatment is carried out using a commercial corona treatment unit model No. CMD-200-MM-PN-EX manufactured by Softal Co. This machine operates at a constant DC voltage of 5000 volts and variable current. The yarns which are corona treated are fed trough at 3.05 m/min using 0.8 amp treatment current. Treatment level is 9.29 m²/min.

Plasma Treatment of Fibers

Plasma treatment is carried out using a system 8060 commercial unit manufactured by Branson/IPC. The conditions under which the yarns were plasma treated were:
Atmosphere: 0₂
Pressure: 0.5 torr (66.5 Pa)
Power: 75 watt
Yarn residence time: 30 sec

### EXAMPLES

Table 6 shows the values of the peeling force between a polyethylene film and a polylactic acid film, between a polypropylene film and a polylactic acid film, and between two polylactic acid films. The multilayered films were prepared by directly depositing one untreated film on the surface-treaded side of a surface-treaded film. Conditioning, sampling and traction experiments are described in, respectively, steps b, c and d of the above-described adhesion force measurement procedure. Different sealing temperatures are used.

| | | Extruded | | Traction sealed at 23° C. | |
|---|---|---|---|---|---|
| | | Polyolefin surface tension | Peeling force | Sealing temperature | Peeling force |
| | Structure | (mN/m) | (N) | (C.) | (N) |
| E1 | PE1/PLA1 | <34, no corona treatment | (0.01 ± 0.00) | 180 | (0.0 ± 0.1) |
| | | | | 190 | (0.2 ± 0.1) |
| E2 | PE1/PLA1 | between 38 and 40 | (0.10 ± 0.02) | 110 | (0.1 ± 0.0) |
| | | | | 120 | (0.1 ± 0.0) |
| | | | | 130 | (0.0 ± 0.0) |
| | | | | 140 | (0.2 ± 0.1) |
| | | | | 145 | (0.1 ± 0.0) |
| | | | | 150 | (0.1 ± 0.0) |
| | | | | 160 | (0.1 ± 0.1) |
| | | | | 170 | (0.1 ± 0.0) |
| | | | | 180 | (0.1 ± 0.0) |
| E3 | PE1/PLA1 | between 42 and 44 | (0.53 ± 0.17) | 105 | (0.4 ± 0.1) |
| | | | | 110 | (0.6 ± 0.1) |
| | | | | 115 | (0.6 ± 0.0) |
| | | | | 120 | (0.2 ± 0.0) |
| | | | | 130 | (0.2 ± 0.0) |
| | | | | 140 | (0.4 ± 0.1) |
| | | | | 150 | (0.5 ± 0.0) |
| | | | | 160 | (0.3 ± 0.1) |
| | | | | 170 | (0.4 ± 0.2) |
| E4 | PE2/PLA1 | <34, no corona treatment | (0.00 ± 0.00) | 180 | (0.0 ± 0.0) |
| | | | | 190 | (0.1 ± 0.0) |
| E5 | PE2/PLA1 | 42 | (0.15 ± 0.12) | 110 | (0.2 ± 0.1) |
| | | | | 115 | (0.1 ± 0.1) |
| | | | | 120 | (0.1 ± 0.0) |
| | | | | 130 | (0.0 ± 0.0) |
| | | | | 140 | (0.1 ± 0.0) |
| | | | | 150 | (0.2 ± 0.1) |
| | | | | 160 | (0.1 ± 0.0) |
| | | | | 170 | (0.3 ± 0.1) |
| E6 | PE3/PLA1 | <34, no corona treatment | (0.00 ± 0.00) | — | — |
| E7 | PE3/PLA1 | 40 | (0.11 ± 0.04) | 120 | (0.1 ± 0.0) |
| | | | | 130 | (0.1 ± 0.0) |
| | | | | 140 | (0.1 ± 0.0) |
| | | | | 150 | (0.2 ± 0.1) |
| | | | | 160 | (0.2 ± 0.1) |
| | | | | 170 | (0.2 ± 0.2) |
| E8 | PP1/PLA1 | <34, no corona treatment | (0.00 ± 0.00) | — | — |
| E9 | PP1/PLA1 | between 38 and 40 | (0.02 ± 0.01) | 110 | (0.0 ± 0.0) |
| | | | | 120 | (0.1 ± 0.0) |
| | | | | 130 | (0.1 ± 0.0) |
| | | | | 140 | (0.0 ± 0.0) |
| | | | | 150 | (0.0 ± 0.0) |
| E10 | PLA1/PLA1 | no corona treatment | — | 70 | (0.1 ± 0.0) |
| | | | | 72 | (0.5 ± 0.2) |

1.-15. (canceled)

16. A multi-layered structure, comprising at least two layers:
a polyethylene layer, comprising polyethylene; and,
a polylactic acid layer, comprising polylactic acid;
wherein the polyethylene layer is corona-, flame- or plasma-treated; and,
wherein the polylactic acid layer is in direct contact with the corona-, flame- or plasma-treated side of the polyethylene layer,
characterised in that the molecular weight distribution M_{w}/Mₙ of the polyethylene is at most 5.0.

17. The multi-layered structure according to claim 16, wherein the molecular weight distribution M_{w}/Mₙ of the polyethylene is at most 4.0.

18. The multi-layered structure according to claim 16, wherein the molecular weight distribution M_{w}/Mₙ of the polyethylene is at most 3.2.

19. The multi-layered structure according to claim 16, wherein the polyethylene layer is corona-treated.

20. The multi-layered structure according to claim 16, wherein the polyethylene layer comprises a polyethylene produced with a single site catalyst.

21. The multi-layered structure according to claim 16, wherein the multi-layered structure is a film.

22. The multi-layered structure according to claim 16, wherein the multi-layered structure is a reinforcing fibre compatible with polyester or polyvinylester resins.

23. The multi-layered structure according to claim 16, comprising at least a second polyethylene layer comprising a second polyethylene, wherein the second polyethylene layer is corona-, flame- or plasma-treated.

24. The multi-layered structure according to claim 16, comprising one or more additional layers selected from the group comprising: fabric, paper, card, cardboard, metal, and polymer.

25. The multi-layered structure according to claim 16, wherein the polyethylene is a copolymer with hexene as comonomer, of at least 1 to at most 10 wt % of hexane with wt % based on the total weight of the polyethylene, wherein wt % is measured by ¹³C NMR.

26. A food or beverage packaging article comprising the multi-layered structure according to claim 16.

27. A method for manufacturing a multi-layered structure, comprising the steps of:
a. providing a polyethylene layer comprising polyethylene;
b. corona-, flame- or plasma-treating the polyethylene layer, creating a surface-treated layer;
c. providing a polylactic acid layer comprising polylactic acid; and,
d. depositing the polylactic acid layer on the surface-treated side of the surface treated layer characterised in that the molecular weight distribution (weight average molecular weight/number average molecular weight) M_{w}/Mₙ of the polyethylene is at most 5.0.

28. The method according to claim 27, wherein the molecular weight distribution (weight average molecular weight/number average molecular weight) M_{w}/Mₙ of the polyethylene is at most 4.0, preferably at most 3.5, preferably at most 3.2, preferably at most 3.0, for example at most 2.8, wherein the molecular weight distribution (weight average molecular weight/number average molecular weight) M_{w}/Mₙ is measured by size exclusion chromatography (SEC).

29. The method according to claim 27 for manufacturing a multi-layered structure according to claim 16.

30. Use of a polylactic acid layer, comprising polylactic acid, as a tie layer directly applied on a corona-, flame- or plasma-treated side of a polyethylene layer, comprising polyethylene, in a multi-layered structure, optionally wherein the molecular weight distribution (weight average molecular weight/number average molecular weight) M_{w}/Mₙ of the polyethylene is at most 5.0, wherein the molecular weight distribution (weight average molecular weight/number average molecular weight) M_{w}/Mₙ is measured by size exclusion chromatography (SEC).
